(19) United States
(12) Patent Application Publication
(10) Pub. No.: US 2026/0253923 A1
(43) Pub. Date: Aug. 27, 2026

(54) FUEL CELL SYSTEM INCLUDING CATHODE EXHAUST RESTRICTOR PLATE

(71) Applicant: Bloom Energy Corporation, San Jose, CA (US)

(72) Inventors: Shiva Teja KONETI, Santa Clara, CA (US); Ralion HERZOG, Sunnyvale, CA (US); Kyle KEKELIS, San Jose, CA (US); Nandan JOSHI, San Jose, CA (US)

(21) Appl. No.: 19/544,474

(22) Filed: Feb. 19, 2026

Related U.S. Application Data
(60) Provisional application No. 63/762,977, filed on Feb. 25, 2025.

(51) Int. Cl. H01M 8/04089; H01M 8/04007; H01M 8/04014; H01M 8/04111; H01M 8/04746; H01M 8/0662; H01M 8/12; H01M 8/2483

(52) U.S. Cl. CPC H01M 8/04097; H01M 8/04014; H01M 8/04074; H01M 8/04111; H01M 8/04761; H01M 8/04783; H01M 8/0662; H01M 8/12; H01M 8/2483

(57) ABSTRACT

A fuel cell system includes a column of fuel cells, an anode tail gas oxidizer (ATO) configured to oxidize an anode exhaust output from the column using a cathode exhaust output from the column, and a flow restrictor located at a cathode exhaust inlet to the ATO and configured to restrict a flow of the cathode exhaust into the ATO.

### FIELD

Aspects of the present invention relate to fuel cell systems and more particularly, to fuel cell systems including a cathode exhaust restrictor plate and methods of operating thereof.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, a fuel cell system comprises a column of fuel cells; an anode tail gas oxidizer (ATO) configured to oxidize an anode exhaust output from the column using a cathode exhaust output from the column; and a flow restrictor located at a cathode exhaust inlet to the ATO and configured to restrict a flow of the cathode exhaust into the ATO.

According to various embodiments, a method of operating a fuel cell system comprises providing air and fuel to a column of fuel cells to generate electricity, an anode exhaust and a cathode exhaust; providing the cathode exhaust through a flow restrictor to an anode tail gas oxidizer (ATO); and oxidizing the anode exhaust in the ATO using the cathode exhaust.

### BRIEF DESCRIPTION OF THE DRAWINGS

The accompanying drawings, which are incorporated herein and constitute part of this specification, illustrate example embodiments of the invention, together with the general description given above and the detailed description given below.

FIG. 1A is a perspective view of a solid oxide fuel cell (SOFC) stack, and FIG. 1B is a side cross-sectional view of a portion of the stack of FIG. 1A.

FIG. 2A is a schematic representation of a fuel cell system, according to various embodiments of the present disclosure, and FIG. 2B is a cross-sectional view of a hotbox of the fuel cell system of FIG. 2A.

FIG. 3A is a partially exploded perspective cross-sectional view of the hotbox of FIG. 2B, according to various embodiments of the present disclosure, FIG. 3B is an enlarged view of portion of FIG. 3A, FIG. 3C is a cross-sectional view showing another portion of the hotbox of FIG. 2B, and FIG. 3D is a top view of a restrictor plate shown in FIGS. 3A, 3B, and 3C.

FIG. 4 is a top view of an alternative restrictor plate, according to an alternative embodiment of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims. Herein, “about” refers to a variation of +/−5% or less.

In a high temperature fuel cell system, such as a solid oxide fuel cell (SOFC) system, an oxidizing flow is directed to the cathode (i.e., air) side of the fuel cell while a fuel flow is directed to the anode (i.e., fuel) side of the fuel cell. The oxidizing flow is typically air, while the fuel flow can be hydrogen (H₂) or a hydrocarbon fuel, such as methane, natural gas, propane (LPG), ethanol, or methanol, or another suitable fuel, such as ammonia. The fuel cell, operating at a typical temperature between 700° C. and 950° C., enables the transport of negatively charged oxygen ions from the cathode flow stream to the anode flow stream, where the oxygen ions combine with either free hydrogen or hydrogen in a hydrocarbon or ammonia molecule to form water vapor and optionally combine with carbon monoxide to form carbon dioxide. The excess electrons from the negatively charged ions are routed back to the cathode side of the fuel cell through an electrical circuit completed between anode and cathode, resulting in an electrical current flow through the circuit, such that the SOFC system generates electricity.

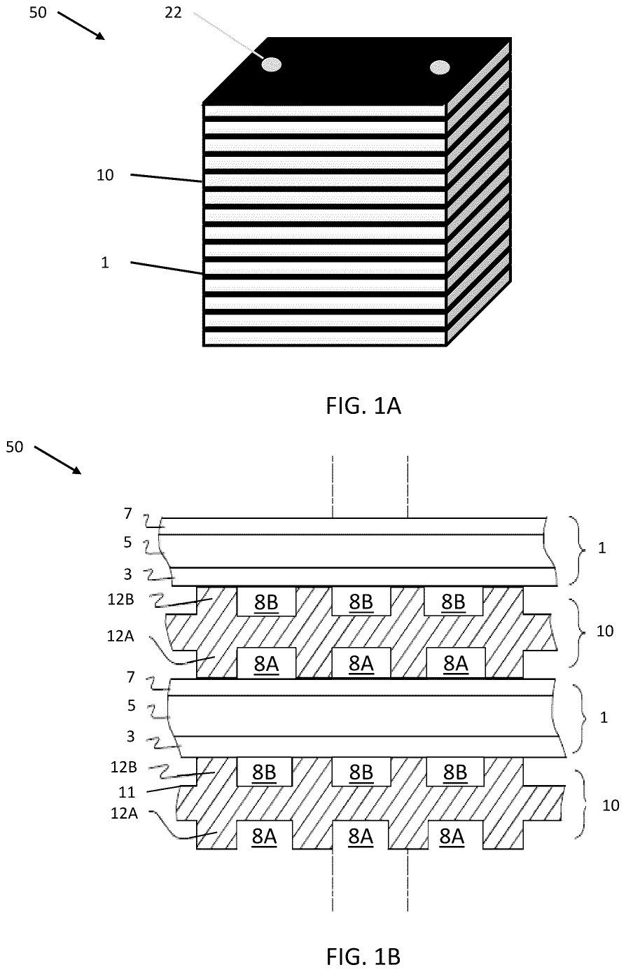

FIG. 1A is a perspective view of a fuel cell stack 50, and FIG. 1B is a side cross-sectional view of a portion of the stack 50 of FIG. 1A. Referring to FIGS. 1A and 1B, the stack 50 includes multiple fuel cells 1 that are separated by interconnects 10, which may also be referred to as gas flow separator plates or bipolar plates. The stack 50 also includes optional internal fuel riser channels 22.

In one embodiment, the fuel cells 1 may be solid oxide fuel cells. Accordingly, the stack 50 may be referred to as a solid oxide fuel cell (SOFC) stack 50. However, other types of fuel cells may be used in the stack. Multiple fuel cell stacks 50 may be arranged in a fuel cell column when stacked on top of each other. However, a fuel cell column may also refer to a fuel cell stack comprised of large number of SOFCs. Each solid oxide fuel cell 1 includes an air electrode (e.g., cathode) 3, a solid oxide electrolyte 5, and a fuel electrode (e.g., anode) 7. The air electrode 3 may comprise lanthanum strontium manganite (LSM) or other similar perovskite materials. The solid oxide electrolyte 5 may comprise a ceramic electrolyte, such as yttria stabilized zirconia (YSZ), scandia stabilized zirconia (SSZ), scandia and ceria stabilized zirconia or scandia, yttria and ceria stabilized zirconia. The fuel electrode 7 may comprise a nickel-YSZ, a nickel-SSZ or nickel-doped ceria cermet.

Each interconnect 10 electrically connects adjacent fuel cells 1 in the stack 50. In particular, an interconnect 10 may electrically connect the fuel electrode 7 of one fuel cell 1 to the air electrode 3 of an adjacent fuel cell 1. FIG. 1B shows that the lower fuel cell 1 is located between two interconnects 10. Each interconnect 10 includes fuel ribs 12A that at least partially define fuel channels 8A and air ribs 12B that at least partially define air channels 8B. The interconnect 10 may comprise a Cr—Fe alloy (e.g., 4-6 atomic percent iron and balance chromium) or a stainless steel interconnect. The interconnect 10 may operate as a gas-fuel separator that separates a fuel flowing to the fuel electrode 7 of one fuel cell 1 in the stack 50 from oxidant, such as air, flowing to the air electrode 3 of an adjacent fuel cell 1 in the stack 50. At either end of the stack 50, there may be an air end plate or fuel end plate (not shown) for providing air or fuel, respectively, to the end electrode. The air or fuel end plate may comprise an interconnect 10.

A fuel cell column may include one stack 50 or multiple stacks 50 arranged on one another. The column may be internally or externally manifolded for fuel and/or air. Optional anode splitter plates may be located between adjacent stacks 50 to provide fuel to the cells of each stack 50 as described in U.S. Pat. No. 10,511,047B2 , which is incorporated herein by reference in its entirety.

While a co-flow or counter-flow interconnect 10 is illustrated in FIG. 1B, in alternative embodiments, the interconnect 10 may comprise a crossflow interconnect in which the air and fuel channels extend perpendicular to each other, as described in U.S. Pat. No. 11,355,762B2 , which is incorporated herein by reference in its entirety. For example, such interconnects 10 may include two or more fuel holes per side of the interconnect.

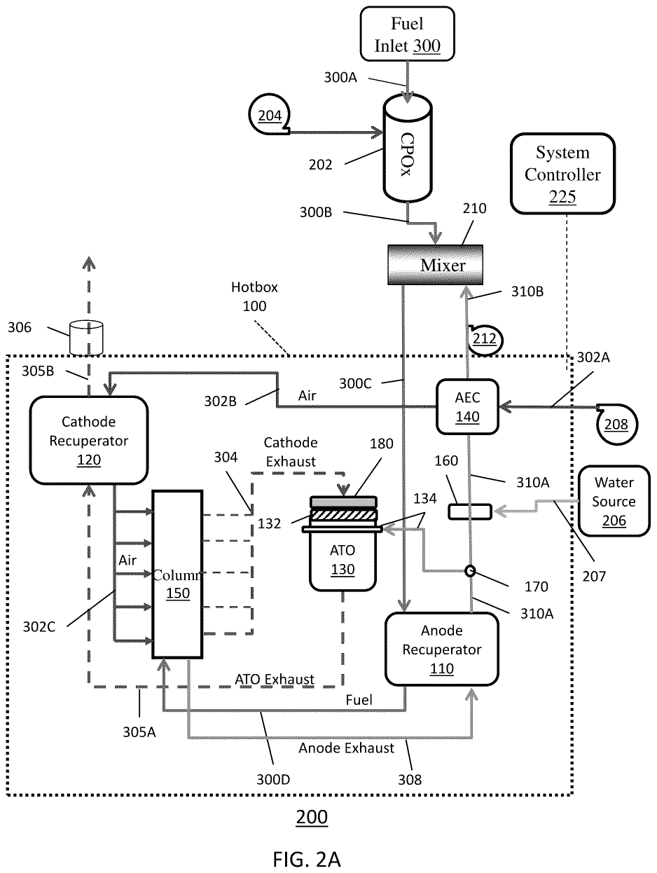

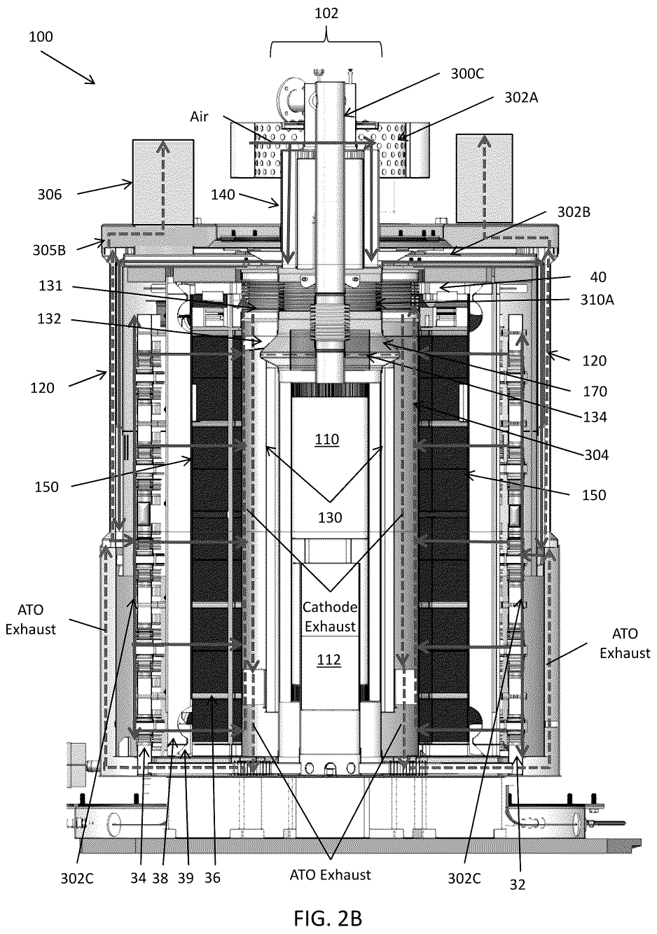

FIG. 2A is a schematic representation of a fuel cell system, such as a SOFC system 200, according to various embodiments of the present disclosure, and FIG. 2B is a cross-sectional view of a hotbox 100 of the fuel cell system 200 of FIG. 2A. Referring to FIGS. 2A and 2B, the system 200 includes the hotbox 100 and various components disposed therein or adjacent thereto. The hotbox 100 may contain at least one fuel cell column 150, which may include one or more fuel cell stacks, such as solid oxide cell stacks 50, as shown in FIGS. 1A and 1B.

The hotbox 100 may also contain an anode recuperator heat exchanger 110, a cathode recuperator heat exchanger 120, an anode tail gas oxidizer (ATO) 130, an anode exhaust cooler heat exchanger 140, an optional splitter 170, and a water injector 160. The system 200 may also include a catalytic partial oxidation (CPOx) reactor 202, a mixer 210, a CPOx blower 204 (e.g., air blower), a system blower 208 (e.g., air blower), and an anode recycle blower 212, which may be disposed outside of the hotbox 100. However, the present disclosure is not limited to any particular location for each of the components with respect to the hotbox 100.

The anode recuperator 110, the ATO 130, and the anode exhaust cooler 140 may be arranged in a central column 102 and surrounded by the fuel cell columns 150. In particular, the anode exhaust cooler 140 may be disposed above the anode recuperator 110, which may be surrounded by the ATO 130. The cathode recuperator 120 may surround the columns 150 and may be disposed adjacent to an outer wall of the hotbox 100.

The CPOx reactor 202 receives a fuel inlet stream from a fuel inlet 300, through a fuel conduit 300A. The fuel inlet 300 may be a fuel tank or a utility natural gas line including a valve to control an amount of fuel provided to the CPOx reactor 202. The CPOx blower 204 may provide air to the CPOx reactor 202 during system start-up. The fuel and/or air may be provided to the mixer 210 by a fuel conduit 300B. Fuel flows from the mixer 210 to the anode recuperator 110 through a fuel conduit (i.e., fuel inlet conduit) 300C. The fuel is heated in the anode recuperator 110 by the fuel exhaust from the fuel cell column 150, and the fuel then flows from the anode recuperator 110 to the column 150 through a fuel conduit 300D.

The system blower 208 may be configured to provide an air stream (e.g., air inlet stream) to the anode exhaust cooler 140 through an air conduit 302A. The air stream flows from the anode exhaust cooler 140 to the cathode recuperator 120 through an air conduit 302B. The air stream is heated by the ATO exhaust in the cathode recuperator 120. The air stream then flows from the cathode recuperator 120 to the column 150 through an air conduit 302C.

Anode exhaust (e.g., a fuel exhaust stream) generated in the column 150 is provided to the anode recuperator 110 through an anode exhaust conduit 308. The anode exhaust may contain unreacted fuel and may also be referred to herein as fuel exhaust. The anode exhaust may be provided from the anode recuperator 110 to the mixer 210 by a recycling conduit, which may include a first recycling conduit 310A and a second recycling conduit 310B. In particular, the first recycling conduit 310A may fluidly connect an outlet of the anode recuperator 110 to an inlet of the anode exhaust cooler 140. The second recycling conduit 310B may fluidly connect an outlet of the anode exhaust cooler 140 to an inlet of the mixer 210.

Water flows from a water source 206, such as a water tank or a water pipe, to the water injector 160 through a water conduit 207. The water injector 160 may be configured to inject water into anode exhaust flowing through the first recycling conduit 310A. Heat from the anode exhaust (also referred to as a recycled anode exhaust stream) vaporizes the water to generate steam which humidifies the anode exhaust. The humidified anode exhaust is provided to the anode exhaust cooler 140. Heat from the anode exhaust provided to the anode exhaust cooler 140 may be transferred to the air inlet stream provided from the system blower 208 to the cathode recuperator 120. The cooled humidified anode exhaust may then be provided from the anode exhaust cooler 140 to the mixer 210 via the second recycling conduit 310B. The anode recycle blower 212 may be configured to move the anode exhaust though the second recycling conduit 310B.

The mixer 210 is configured to mix the humidified anode exhaust with fresh fuel (i.e., fuel inlet stream). This humidified fuel mixture may then be heated in the anode recuperator 110 by the anode exhaust, before being provided to the column 150. The system 200 may also include one or more fuel reforming catalysts 112 located inside and/or downstream of the anode recuperator 110, as shown in FIG. 2B. The reforming catalyst(s) 112 reform the humidified fuel mixture before it is provided to the column 150.

The splitter 170 may be operatively connected to the first recycling conduit 310A (e.g., upstream of the water injector 160) and to an ATO injector 134. Thus, the splitter 170 is configured to divert a portion of the anode exhaust to the ATO 130 via the ATO injector 134. In one embodiment shown in FIG. 2B, the ATO injector 134 comprises one or more slits in the wall of the splitter 170.

The ATO injector 134 is configured to inject a portion of the anode exhaust received from the first recycling conduit 310A into the ATO 130. Cathode exhaust (e.g., air exhaust) generated in the column 150 may be provided through the cathode exhaust conduit 304 into the ATO 130. In particular, the cathode exhaust may move vertically through the cathode exhaust conduit 304 (i.e., the space between the columns 150 and the ATO 130) before entering an annular ATO inlet 131 (i.e., the cathode exhaust inlet to the ATO) disposed at the top of the ATO 130. The cathode exhaust may enter the ATO 130 through the annular ATO inlet 131 and then may be mixed with the anode exhaust injected into the ATO 130 by the ATO injector 134. The ATO 130 may include vanes 132 located at the top of the ATO 130 (e.g., below the annular ATO inlet 131) and configured to circumferentially swirl the cathode exhaust entering the ATO 130 to facilitate the mixing. The vanes 132 may be located above the ATO injector 134.

The mixture of the anode exhaust and the cathode exhaust may be oxidized in the ATO 130 to generate an ATO exhaust. The ATO 130 may include an anode exhaust oxidation catalyst located between the inner and outer walls of the ATO. The ATO exhaust flows from the ATO 130 through ATO exhaust conduit 305A to the cathode recuperator 120. ATO exhaust flows from the cathode recuperator 120 into ATO exhaust conduit 305B and then flows out of the hotbox 100 through exhaust conduits 306.

In one embodiment shown in FIG. 2B, each column 150 may include one or more stacks 50, a fuel inlet conduit 32, an anode exhaust conduit 34, and anode feed/return assemblies 36 (e.g., anode splitter plates (ASPs) 36). Each column 150 may also include side baffles 38 and a compression assembly 40. The side baffles 38 may be connected to the compression assembly 40 and an underlying stack component by ceramic connectors 39. The fuel inlet conduit 32 is fluidly connected to the ASPs 36 and is configured to provide the fuel feed to each ASP 36, and anode exhaust conduit 34 is fluidly connected to the ASPs 36 and is configured to receive anode fuel exhaust from each ASP 36. The ASPs 36 are disposed between the stacks 50 and are configured to provide a fuel containing fuel feed to the stacks 50 and to receive anode fuel exhaust from the stacks 50. In one embodiment, a topmost ASP 36 is located over the topmost stack 50 of the column 150, such that there are no additional stacks 50 located over the topmost ASP 36 of the column 150. The ASPs 36 may be fluidly connected to internal fuel riser channels 22 formed in the stacks 50, as described above.

The system 200 may further a system controller 225 configured to control various elements of the system 200. The controller 225 may include a central processing unit configured to execute stored instructions. For example, the controller 225 may be configured to control fuel and/or air flow through the system 200, by controlling the blowers 208 and 212, fuel inlet valve(s) in the fuel source 300, etc., according to fuel composition data, temperature data, electrical data, or the like.

The present inventors have determined that during steady-state operations, a pressure on the anode side of the fuel cells (i.e., anode side pressure) may be greater than a pressure on the cathode side of the fuel cells (i.e., cathode side pressure), resulting in a cell pressure differential. In particular, the fuel inlet stream pressure in conduit 300D may be greater than the cathode exhaust pressure in conduit 304. This cell pressure difference may be more pronounced in systems which include a topmost ASP 36 which does not underlie a fuel cell stack 50 at the top of the column 150. In case of counter-flow fuel and air directions in the columns 150, this pressure differential may generate a force normal to the plane of the fuel cells 1 in the columns 150, which may result in cracking of ceramic SOFCs and/or other damage.

The cell pressure differential may be reduced or eliminated by reducing the fuel flow rate and/or increasing the system air flow rate flow (i.e., the air inlet stream flow rate). However, decreasing the fuel flow rate decreases the amount of power generated by the columns 150. Likewise, increasing the air flow rate by increasing the air blower 208 speed may result in certain fuel cells or fuel cell stacks operating at temperatures that are less than optimal, which may reduce the system efficiency and/or fuel utilization.

The present inventors realized that adding an air flow restrictor to the fuel cell system increases the pressure of air flowing across the fuel cells 1 without increasing the air inlet stream flow rate. The increased air pressure in the columns 150 decreases or eliminates the cell pressure differential without the need to reduce the fuel flow rate and/or to increase the air inlet stream flow rate. In one embodiment, the flow restrictor may comprise an air flow restrictor plate 180 which is located at the top of the ATO 130, downstream of the columns 150. Thus, the restrictor plate 180 restricts the flow of the cathode exhaust stream exiting the columns 150 to increase the pressure of the cathode exhaust stream.

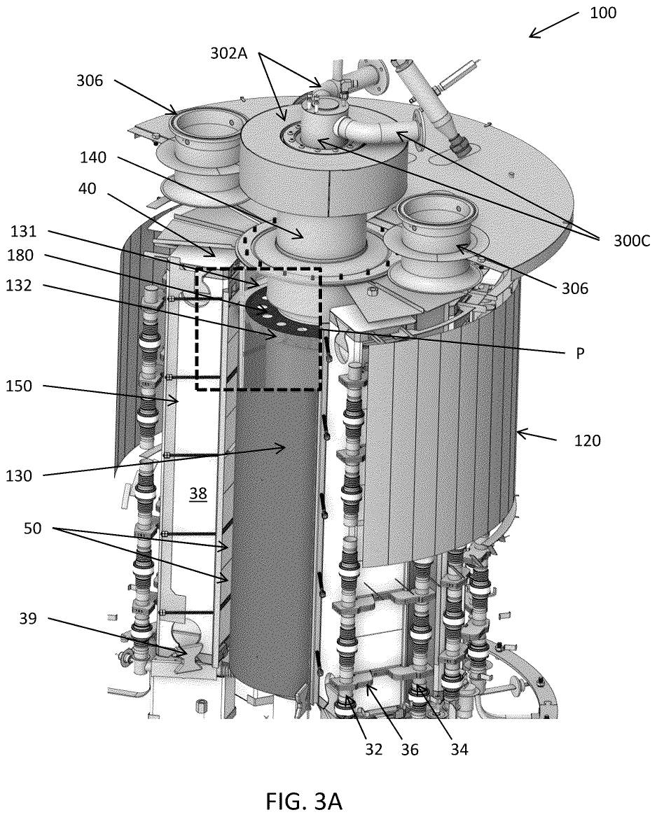

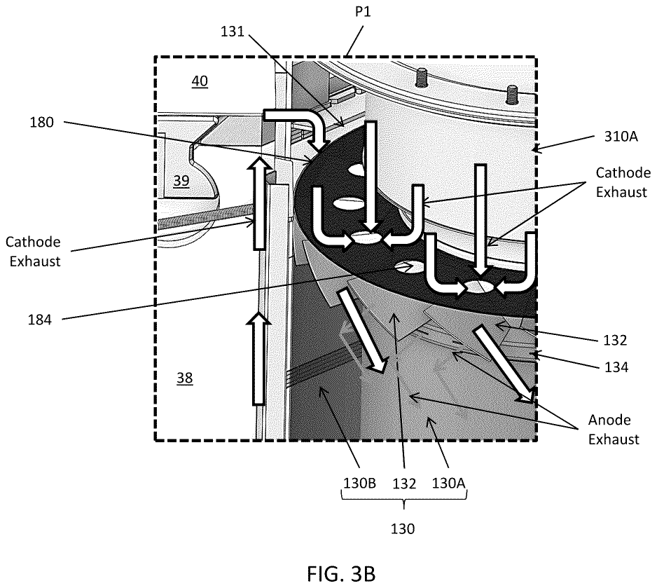

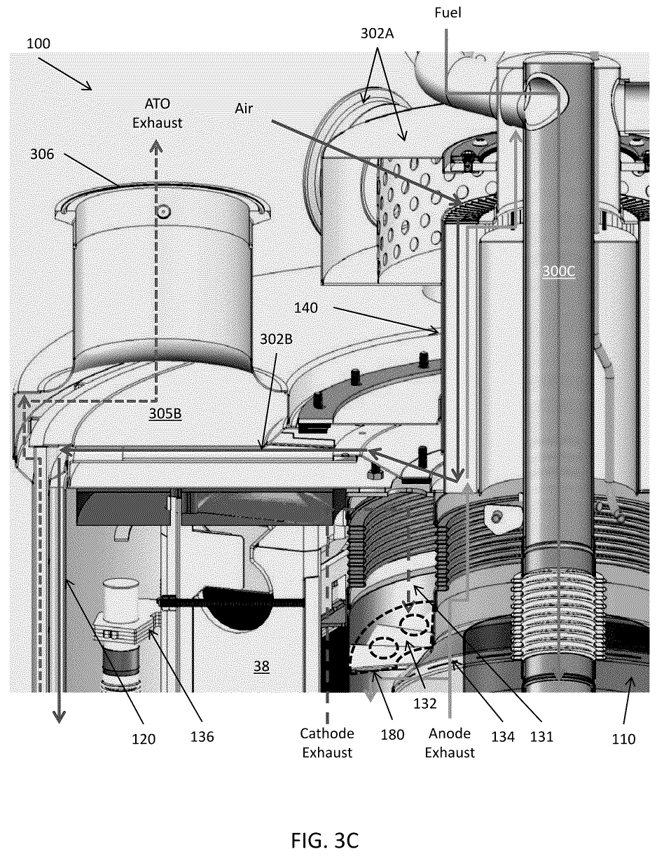

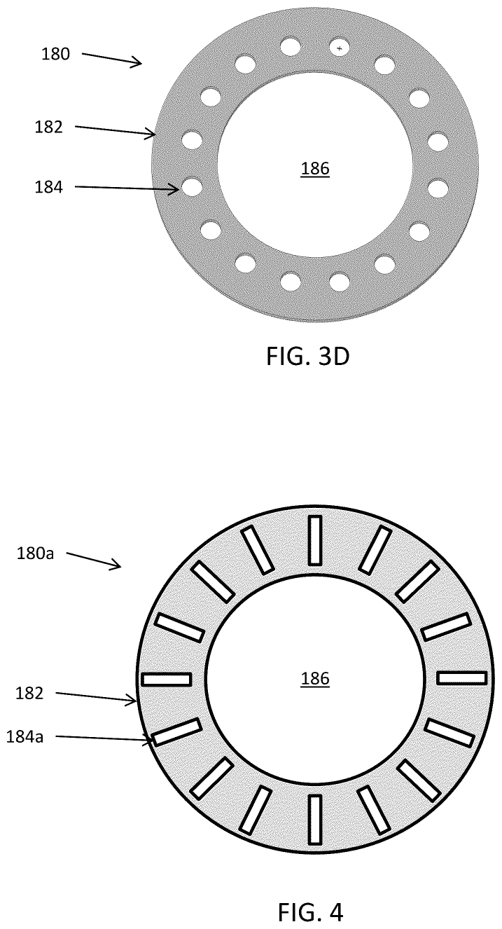

FIG. 3A is a partially exploded perspective cross-sectional view of the hotbox 100, according to various embodiments of the present disclosure, FIG. 3B is an enlarged view of portion P of FIG. 3A, FIG. 3C is a cross-sectional view showing another portion of the hotbox 100, and FIG. 3D is a top view of the restrictor plate 180 shown in FIGS. 3A, 3B, and 3C.

Referring to FIGS. 2A and 3A-3C, the restrictor plate 180 may be disposed on or adjacent to the inlet of the ATO 130, such that the restrictor plate 180 restricts the flow of cathode exhaust from the columns 150 into the ATO 130. For example, an inner edge of the restrictor plate 180 may contact an inner cylinder 130A of the ATO 130 and an outer edge of the restrictor plate 180 may contact an outer cylinder 130B of the ATO 130, such that the restrictor plate 180 restricts the flow of the cathode exhaust into the ATO 130. This increases the pressure of the air flowing across the fuel cells 1 of the column 150 and reduces or eliminates the cell pressure differential across the fuel cells 1.

In one embodiment, the restrictor plate 180 may include an annular body 182, flow apertures (i.e., openings) 184 in the annular body 182, and a central opening 186 surrounded by the annular body 182. The fuel conduit 300C and the surrounding first recycling conduit 310A may extend through the central opening 186 in the restrictor plate 180. Thus, the annular body 182 of restrictor plate 180 surrounds the fuel conduit 300C and the first recycling conduit 310A. Cathode exhaust output from the columns 150 may be forced to flow through the flow apertures 184 in the restrictor plate 180 before entering the ATO 130. As shown in FIG. 3D, the flow apertures 184 may be through holes that are circular in shape. However, the present disclosure is not limited thereto. For example, in alternative embodiments, the flow apertures 184 may be linear, ovoid, arcuate, polygonal, or the like, as shown in FIG. 4.

In some embodiments, the restrictor plate 180 may include a number of flow apertures 184 that corresponds to the number of vanes 132 included in the ATO 130. For example, the restrictor plate 180 may include at least one flow aperture 184 to direct cathode exhaust toward each vane 132. The flow apertures 184 may be configured to form high pressure jets of cathode exhaust that are directed laterally by the vanes 132, such that the vanes 132 generate a turbulent circumferential cathode exhaust within the ATO 130.

The swirled cathode exhaust may then be mixed with anode exhaust injected into the ATO 130 through the ATO injector 134. The swirling of the cathode exhaust may increase mixing of the cathode exhaust and the injected anode exhaust. The mixture may be oxidized in the ATO 130 to form the ATO exhaust.

The restrictor plate 180 may induce a downstream pressure drop in the ATO 130 and may also induce an upstream pressure increase, with respect to the cathode exhaust flow direction. Since the columns 150 are disposed upstream of the restrictor plate 180, the restrictor plate 180 may increase the cathode-side pressure within the fuel cells 1 of the columns 150. If the anode side pressure is higher generally than the cathode side pressure, increasing the cathode side pressure reduces the cell pressure differential in the columns 150 (i.e., a pressure difference between an anode pressure and a cathode side pressure applied to the cells 1 of the columns 150). Accordingly, the restrictor plate 180 may prevent and/or reduce fuel cell 1 damage due to an excessive cell pressure differential by reducing the cell pressure differential in the columns 150.

In some embodiments the restrictor plate 180 may be configured to increase the pressure of the cathode exhaust exiting the columns 150, such that the cell pressure differential is less than 0.7 psi, such as from 0 to 0.65 psi, for example, from about 0.1 psi to about 0.6 psi, including from about 0.2 psi to about 0.5 psi, for example from about 0.3 psi to about 0.4 psi, with the anode side pressure being equal to or greater than the cathode side pressure.

In various embodiments, the restrictor plate 180 may have a perforation percentage that ranges from about 5% to about 20%, such as from about 6% to about 12%, including from about 7 to about 10%. Herein, the “perforation percentage” refers to an amount of the surface area of a restrictor plate 180 that is occupied by flow apertures (e.g., an amount by which the surface area of the body 182 is reduced to form the flow apertures 184). Thus, the body 182 comprises from about 80% to about 95% of the total surface area of the restrictor plate 180 excluding the central opening 186, and a ratio of the surface area of the apertures 184 to the surface area of the of the body 182 ranges from 5:95 to 20:80. In other words, the perforation percentage corresponds to the percentage of the annular ATO inlet 131 that remains unblocked by the restrictor plate 180. For example, a restrictor plate 180 having a perforation percentage of 5% corresponds to a 95% reduction in the surface area of the annular ATO inlet 131. As such, the restrictor plate 180 may cover from about 80% to about 95%, such as from about 90% to about 93% of the annular ATO inlet 131. The perforation percentage may be determined based on a desired pressure drop across the electrochemical cells. If a different pressure drop is desired, then the restrictor plate 180 may be substituted with a different restriction plate 180 having a different perforation percentage that corresponds to the desired pressure drop.

FIG. 4 is a top view of an alternative restrictor plate 180a, according to an alternative embodiment of the present disclosure. The restrictor plate 180a may be similar to the restrictor plate 180. As such, only the differences therebetween will be discussed in detail.

Referring to FIGS. 3B and 4, the restrictor plate 180a may be disposed over the vanes 132 at an inlet of the ATO 130. The restrictor plate 180a may include an annular body 182, flow apertures 184a, and a central opening 186. The flow apertures 184a may be rectangular and may be configured to direct the cathode exhaust toward a larger portion of the vanes 132. In particular, the rectangular flow apertures 184a may be radially arranged lengthwise radially around the central column 102 to direct velocity cathode exhaust onto more of the vanes 132 in a radial direction. As such, the vanes 132 may more effectively swirl the cathode exhaust, which may improve mixing of the cathode exhaust with anode exhaust injected into the ATO 130 by the ATO injector 134.

The fuel cell systems of various embodiments may provide a benefit to the climate by reducing greenhouse gas emissions.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A fuel cell system, comprising:
a column of fuel cells;
an anode tail gas oxidizer (ATO) configured to oxidize an anode exhaust output from the column using a cathode exhaust output from the column; and
a flow restrictor located at a cathode exhaust inlet to the ATO and configured to restrict a flow of the cathode exhaust into the ATO.

2. The fuel cell system of claim 1, wherein the flow restrictor comprises a restrictor plate comprising an annular body and flow apertures that extend through the annular body.

3. The fuel cell system of claim 2, wherein during operation of the fuel cell system, the restrictor plate is configured to increase a pressure of the cathode exhaust exiting the column.

4. The fuel cell system of claim 3, wherein during operation of the fuel cell system, the restrictor plate is configured such that a cell pressure differential between an anode side and a cathode side of the fuel cells is less than 0.7 pounds per square inch (psi).

5. The fuel cell system of claim 4, wherein the annular body of the restrictor plate covers from about 80% to about 95% of an area of the cathode exhaust inlet to the ATO.

6. The fuel cell system of claim 2, wherein:
the flow apertures are circular, linear, ovoid, arcuate, or polygonal through holes; and
the fuel cells comprise solid oxide fuel cells.

7. The fuel cell system of claim 2, wherein the ATO comprises:
an inner wall;
an outer wall that surrounds the inner wall; and
vanes that extend between the inner and outer walls and that are disposed below the cathode exhaust inlet to the ATO,
wherein:
the flow apertures are configured to direct the cathode exhaust toward each of the vanes; and
the vanes are configured to generate a circumferential flow of the cathode exhaust within the ATO.

8. The fuel cell system of claim 7, further comprising:
an ATO injector located below the vanes and configured to inject a portion of the anode exhaust into the ATO;
a plurality of the fuel cell columns surrounding the ATO;
an anode recuperator heat exchanger that is surrounded by the ATO and configured to heat fuel provided to the plurality of fuel cell columns using the anode exhaust;
an anode exhaust cooler heat exchanger disposed above the anode recuperator heat exchanger and configured to heat air provided to the plurality of fuel cell columns using the anode exhaust output from the anode recuperator; and
a cathode recuperator heat exchanger surrounding the plurality of fuel cell columns and configured to further heat the air provided from the anode exhaust cooler heat exchanger using an exhaust provided from the ATO.

9. The fuel cell system of claim 8, further comprising:
a recycling conduit that fluidly connects an outlet of the anode recuperator heat exchanger to an inlet of the anode exhaust cooler heat exchanger, wherein the annular body of the restrictor plate surrounds the recycling conduit; and
a fuel inlet conduit surrounded by the recycling conduit.

10. The fuel cell system of claim 9, further comprising:
a hotbox housing the plurality of fuel cell columns, the ATO, the anode recuperator heat exchanger, the cathode recuperator heat exchanger and the anode exhaust cooler heat exchanger; and
a system air blower configured to provide air to the plurality of fuel cell columns via the anode exhaust cooler heat exchanger.

11. A method of operating fuel cell system, comprising:
providing air and fuel to a column of fuel cells to generate electricity, an anode exhaust and a cathode exhaust;
providing the cathode exhaust through a flow restrictor to an anode tail gas oxidizer (ATO); and
oxidizing the anode exhaust in the ATO using the cathode exhaust.

12. The method of claim 11, wherein the flow restrictor comprises a restrictor plate comprising an annular body and flow apertures that extend through the annular body.

13. The method of claim 12, wherein the restrictor plate increases a pressure of the cathode exhaust exiting the column.

14. The method of claim 13, wherein a cell pressure differential between an anode side and a cathode side of the fuel cells is less than 0.7 pounds per square inch (psi).

15. The method of claim 14, wherein the annular body of the restrictor plate covers from about 80% to about 95% of an area of a cathode exhaust inlet to the ATO.

16. The method of claim 12, wherein:
the flow apertures are circular, linear, ovoid, arcuate, or polygonal through holes; and
the fuel cells comprise solid oxide fuel cells.

17. The method of claim 12, wherein the ATO comprises:
an inner wall;
an outer wall that surrounds the inner wall; and
vanes that extend between the inner and outer walls and that are disposed below a cathode exhaust inlet to the ATO,
wherein:
the system comprises a plurality of the fuel cell columns surrounding the ATO;
the flow apertures direct the cathode exhaust toward each of the vanes; and
the vanes generate a circumferential flow of the cathode exhaust within the ATO.

18. The method of claim 17, further comprising:
injecting a portion of the anode exhaust into the ATO below the vanes;
heating the fuel using the anode exhaust in an anode recuperator heat exchanger that is surrounded by the ATO;
heating the air using the anode exhaust output from the anode recuperator in an anode exhaust cooler heat exchanger disposed above the anode recuperator heat exchanger; and
further heating the air provided from the anode exhaust cooler heat exchanger using an exhaust provided from the ATO in a cathode recuperator heat exchanger surrounding the plurality of fuel cell columns.

19. The method of claim 18, further comprising:
providing the anode exhaust from an outlet of the anode recuperator heat exchanger to an inlet of the anode exhaust cooler heat exchanger through a recycling conduit, wherein the annular body of the restrictor plate surrounds the recycling conduit; and
providing the fuel through a fuel inlet conduit surrounded by the recycling conduit.

20. The method of claim 19, further comprising:
a hotbox housing the plurality of fuel cell columns, the ATO, the anode recuperator heat exchanger, the cathode recuperator heat exchanger and the anode exhaust cooler heat exchanger; and
a system air blower which provides the air to the plurality of fuel cell columns via the anode exhaust cooler heat exchanger.
